(19) United States
(12) Patent Application Publication
(10) Pub. No.: US 2024/0202685 A1
(43) Pub. Date: Jun. 20, 2024

(54) APPARATUSES AND METHODS FOR PAYMENT DETERMINATIONS

(71) Applicant: Wells Fargo Bank, N.A., San Francisco, CA (US)

(72) Inventors: Kelly HOMRIGHAUSEN, St. Peter, MN (US); Megan HENNING, Medina, MD (US); John MARTS, The Woodlands, TX (US); Tessa C. NATH, San Francisco, CA (US)

(21) Appl. No.: 17/078,639

(22) Filed: Oct. 23, 2020

(51) Int. Cl. G06Q 20/10; G06F 16/955; G06Q 20/02; G06Q 20/40; G06Q 30/00; H04L 29/08

(52) U.S. Cl. CPC G06Q 20/108; G06F 16/955; G06Q 20/023; G06Q 20/4014; G06Q 30/0185; H04L 67/306; G06Q 20/3223

(57) ABSTRACT

Methods, apparatuses, and computer program products are disclosed for providing payment determinations. An example method includes receiving a first user input from a first user device associated with a first user and determining that the first user input includes partial payment data. The method further includes determining supplemental payment data for completing the partial payment data from an enterprise payee database. The enterprise payee database includes authenticated payment data populated by transactions between a plurality of user devices. The method further includes generating complete payment data based upon the partial payment data and the supplemental payment data. The method may, in some instances, include effectuating a transaction between a first user account associated with the first user and a second user account associated with a second user based upon the complete payment data.

### TECHNOLOGICAL FIELD

Example embodiments of the present disclosure relate generally to payment transactions and, more particularly, to generating complete payment data in response to partial user inputs.

### BACKGROUND

Customers, businesses, and other parties to a transaction often are presented with a variety of payment mechanisms for completing a financial transaction. For example, a party to a transaction may be able to select a wire transfer, real-time payment, Automated Clearing House (ACH) payment, or the like to provide payment for a transaction. The required information to complete one or more of these payment mechanisms, however, may not always be available or easily accessible to the user.

### BRIEF SUMMARY

As described above, parties to a financial transaction (e.g., customers, businesses, financial institutions, and/or other entities) are provided with various options for completing the financial transaction. For example, an application may be presented to a user, via a mobile device of the user or otherwise, that allows the user to input information relating to the transaction (e.g., payee, amount, payment type, etc.) in order to complete the transaction between the user and another party to the transaction. In many instances, however, information regarding the payee (e.g., name, account number, etc.) may be unknown to the user such that the user is unable to complete the payment. Furthermore, in some instances, a user may incorrectly input payee information resulting in payment to an incorrect party. As such, current payment systems fail to ensure that accurate payment is timely provided to the intended payee of the transaction resulting in transaction processing inefficiencies experienced by the parties to the transaction. Said differently, the failure of conventional payment systems to address incomplete and/or inaccurate payee information results in increased computational and storage burdens in the effectuation of financial transactions.

To solve these issues and others, example implementations of embodiments of the present disclosure may utilize an enterprise payee database/directory that includes authenticated payment data populated and dynamically updated in real-time by transactions between a plurality of user devices to ensure proper payment determinations. In operation, embodiments of the present disclosure may receive a user input from a first user device associated with a first user that includes partial payment information. The system may determine supplemental payment data that completes the partial payment data from an enterprise payee database that includes authenticated payment data as described above. The system may further generate complete payment data based upon the partial payment data from the first user input and the supplemental payment data. Additional example embodiments, may, in the process of determining supplemental data, obtain candidate payment data with associated confidence parameters and compare the confidence parameters with a confidence threshold of the partial payment data in order to ensure the accuracy of the complete payment data used to complete the transaction. In this way, the inventors have identified that the advent of new payment technologies have created a new opportunity for solutions for providing accurate payment and payee determinations which were historically unavailable. In doing so, such example implementations confront and solve at least two technical challenges: (1) they generate complete payment data that accurately reflects the intended payee of a financial transaction, and (2) they minimize storage and computational burdens associated with payment transaction systems.

Systems, apparatuses, methods, and computer program products are disclosed herein for providing payment determinations. With reference to an example method, a method for providing payment determinations may include receiving a first user input from a first user device associated with a first user and determining that the first user input comprises partial payment data. The method may further include determining supplemental payment data for completing the partial payment data from an enterprise payee database where the enterprise payee database comprises authenticated payment data populated by transactions between a plurality of user devices. The method may further include generating complete payment data based upon the partial payment data and the supplemental payment data.

In some embodiments, the method may further include effectuating a transaction between a first user account associated with the first user and a second user account associated with a second user based upon the complete payment data.

In some embodiments, the method may further include transmitting a notification to the first user device comprising the complete payment data.

In some embodiments, determining the supplemental payment data further includes obtaining candidate payment data based upon the partial payment data where the candidate payment data comprises an associated confidence parameter and determining a confidence threshold based upon the partial payment data. In such an embodiment, the method may further include determining if the confidence parameter of the candidate payment data satisfies the confidence threshold and selecting the candidate payment data as the supplemental payment data in an instance in which the confidence parameter satisfies the confidence threshold. In an instance in which the confidence parameter fails to satisfy the confidence threshold, the method may include transmitting a notification to the first user device requesting a second user input.

In some embodiments, the partial payment data may include partial payee identification data. In such an embodiment, determining the supplemental payment data may further include obtaining candidate payment data comprising payee identification data that completes the partial payee identification data and selecting the candidate payment data comprising the payee identification data as the supplemental payment data.

In some embodiments, the partial payment may include partial transaction data. In such an embodiment, determining the supplemental payment data may further include obtaining candidate payment data comprising transaction data that completes the partial transaction data and selecting the candidate payment data comprising the transaction data as the supplemental payment data.

The above summary is provided merely for purposes of summarizing some example embodiments to provide a basic understanding of some aspects of the disclosure. Accordingly, it will be appreciated that the above-described embodiments are merely examples and should not be construed to narrow the scope or spirit of the disclosure in any way. It will be appreciated that the scope of the disclosure encompasses many potential embodiments in addition to those here summarized, some of which will be further described below.

### BRIEF DESCRIPTION OF THE DRAWINGS

Having described certain example embodiments of the present disclosure in general terms above, reference will now be made to the accompanying drawings. The components illustrated in the figures may or may not be present in certain embodiments described herein. Some embodiments may include fewer (or more) components than those shown in the figures.

FIG. 1 illustrates a system diagram including devices that may be involved in some example embodiments described herein.

FIG. 2 illustrates a schematic block diagram of example circuitry that may perform various operations, in accordance with some example embodiments described herein.

FIG. 3 illustrates an example flowchart for providing payment determinations, in accordance with some example embodiments described herein.

FIG. 4 illustrates an example flowchart for confidence parameter comparisons, in accordance with some example embodiments described herein.

FIG. 5 illustrates an example flowchart for partial payee identification determinations, in accordance with some example embodiments described herein.

FIG. 6 illustrates an example flowchart for partial transaction data determinations, in accordance with some example embodiments described herein.

### DETAILED DESCRIPTION

Some embodiments of the present disclosure will now be described more fully hereinafter with reference to the accompanying drawings, in which some, but not all embodiments are shown. Indeed, the disclosure may be embodied in many different forms and should not be construed as limited to the embodiments set forth herein; rather, these embodiments are provided so that this disclosure will satisfy applicable legal requirements. Like numbers refer to like elements throughout. As used herein, the description may refer to a payment server as an example “apparatus.” However, elements of the apparatus described herein may be equally applicable to the claimed method and computer program product. Thus, use of any such terms should not be taken to limit the spirit and scope of embodiments of the present disclosure.

### DEFINITION OF TERMS

As used herein, the terms “data,” “content,” “information,” “electronic information,” “signal,” “command,” and similar terms may be used interchangeably to refer to data capable of being transmitted, received, and/or stored in accordance with embodiments of the present disclosure. Thus, use of any such terms should not be taken to limit the spirit or scope of embodiments of the present disclosure. Further, where a first computing device is described herein to receive data from a second computing device, it will be appreciated that the data may be received directly from the second computing device or may be received indirectly via one or more intermediary computing devices, such as, for example, one or more servers, relays, routers, network access points, base stations, hosts, and/or the like, sometimes referred to herein as a “network.” Similarly, where a first computing device is described herein as sending data to a second computing device, it will be appreciated that the data may be sent directly to the second computing device or may be sent indirectly via one or more intermediary computing devices, such as, for example, one or more servers, remote servers, cloud-based servers (e.g., cloud utilities), relays, routers, network access points, base stations, hosts, and/or the like.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

As used herein, the phrases “in one embodiment,” “according to one embodiment,” “in some embodiments,” and the like generally refer to the fact that the particular feature, structure, or characteristic following the phrase may be included in at least one embodiment of the present disclosure. Thus, the particular feature, structure, or characteristic may be included in more than one embodiment of the present disclosure such that these phrases do not necessarily refer to the same embodiment.

As used herein, the word “example” is used to mean “serving as an example, instance, or illustration.” Any implementation described herein as “example” is not necessarily to be construed as preferred or advantageous over other implementations.

As used herein, the terms “user device,” “mobile device,” “electronic device” and the like refer to computer hardware that is configured (either physically or by the execution of software) to access one or more services made available by a payment server (e.g., apparatus or computing device of the present disclosure) and, among various other functions, is configured to directly, or indirectly, transmit and receive data. Example user devices may include a smartphone, a tablet computer, a laptop computer, a wearable device (e.g., smart glasses, smart watch, or the like), and the like. In some embodiments, a user device may include a “smart device” that is equipped with a chip or other electronic device that is configured to communicate with the apparatus via Bluetooth, NFC, Wi-Fi, 3G, 4G, 5G, RFID protocols, and the like. By way of a particular example, a user device may be a mobile phone equipped with a Wi-Fi radio that is configured to communicate with a Wi-Fi access point that is in communication with the payment server 200 or other computing devices via a network.

As used herein, the term “first user device” refers to a user device as defined above that is associated with a first user which may be in network communication with the payment server, and/or the second user device. For example, a first user device may be smartphone or computing device of a user that may request, receive, and/or provide data to or from one of the devices described above. By way of a particular example, a first user device may include a smartphone associated with a payor of a financial transaction.

As used herein, the term “second user device” refers to a user device as defined above that is associated with a second user which may be in network communication with the payment server, and/or the first user device. For example, a second user device may be smartphone or computing device of a user that may request, receive, and/or provide data to or from one of the devices described above. By way of a particular example, a second user device may include a smartphone associated with a payee of a financial transaction.

As used herein, the terms “enterprise payee database” or “enterprise payee directory” refer to a data structure or repository for storing user data, user parameters, financial transaction data, payment data, and the like from a plurality of user devices, users, and financial transactions. As described herein, the enterprise payee database includes authenticated payment data that is populated by transactions between a plurality of user devices. Furthermore, the enterprise payee database is dynamically updated in real-time or substantially real-time to include new financial transactions and/or modifications to prior financial transactions (e.g. dynamically updated payment data). In order to provide authenticated or otherwise valid payment data, the enterprise payee database may exist as part of a financial institution's server or system. The enterprise payee database may be accessible by one or more software applications of the payment server 200.

As used herein, the term “computer-readable medium” refers to non-transitory storage hardware, non-transitory storage device or non-transitory computer system memory that may be accessed by a controller, a microcontroller, a computational system or a module of a computational system to encode thereon computer-executable instructions or software programs. A non-transitory “computer-readable medium” may be accessed by a computational system or a module of a computational system to retrieve and/or execute the computer-executable instructions or software programs encoded on the medium. Exemplary non-transitory computer-readable media may include, but are not limited to, one or more types of hardware memory, non-transitory tangible media (for example, one or more magnetic storage disks, one or more optical disks, one or more USB flash drives), computer system memory or random access memory (such as, DRAM, SRAM, EDO RAM), and the like.

Having set forth a series of definitions called-upon throughout this application, an example system architecture and example apparatus is described below for implementing example embodiments and features of the present disclosure.

### Device Architecture and Example Apparatus

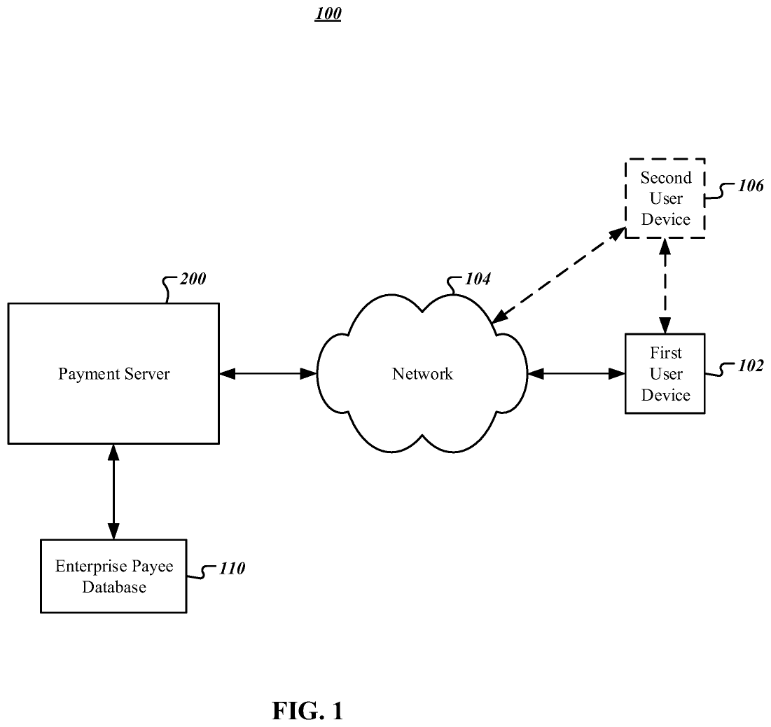

With reference to FIG. 1, an example system 100 is illustrated with an apparatus (e.g., a payment server 200) communicably connected via a network 104 to a first user device 102 and, in some embodiments, a second user device 106. The example system 100 may also include an enterprise payee database 110 that may be hosted by the payment server 200 or otherwise hosted by devices in communication with the payment server 200.

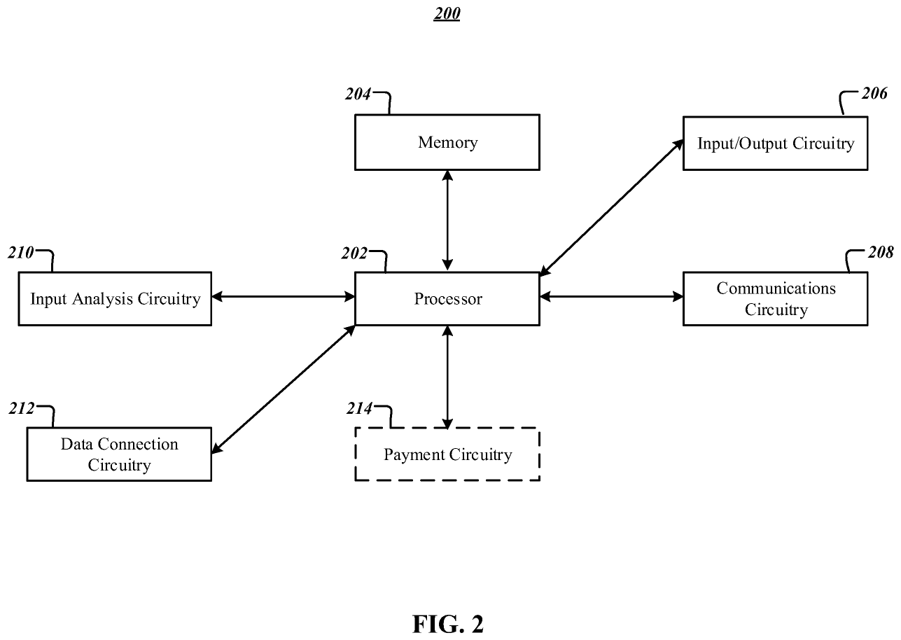

The payment server 200 may include circuitry, networked processors, or the like configured to perform some or all of the apparatus-based (e.g., payment server-based) processes described herein, and may be any suitable network server and/or other type of processing device. In this regard, payment server 200 may be embodied by any of a variety of devices. For example, the payment server 200 may be configured to receive/transmit data and may include any of a variety of fixed terminals, such as a server, desktop, or kiosk, or it may comprise any of a variety of mobile terminals, such as a portable digital assistant (PDA), mobile telephone, smartphone, laptop computer, tablet computer, or in some embodiments, a peripheral device that connects to one or more fixed or mobile terminals. Example embodiments contemplated herein may have various form factors and designs but will nevertheless include at least the components illustrated in FIG. 2 and described in connection therewith. In some embodiments, the payment server 200 may be located remotely from the first user device 102, the second user device 106, and/or enterprise payee database 110, although in other embodiments, the payment server 200 may comprise the first user device 102, the second user device 106, and/or the enterprise payee database 110. The payment server 200 may, in some embodiments, comprise several servers or computing devices performing interconnected and/or distributed functions. Despite the many arrangements contemplated herein, the payment server 200 is shown and described herein as a single computing device to avoid unnecessarily overcomplicating the disclosure.

The network 104 may include one or more wired and/or wireless communication networks including, for example, a wired or wireless local area network (LAN), personal area network (PAN), metropolitan area network (MAN), wide area network (WAN), or the like, as well as any hardware, software and/or firmware for implementing the one or more networks (e.g., network routers, switches, hubs, etc.). For example, the network 104 may include a cellular telephone, mobile broadband, long term evolution (LTE), GSM/EDGE, UMTS/HSPA, IEEE 802.11, IEEE 802.16, IEEE 802.20, Wi-Fi, dial-up, and/or WiMAX network. Furthermore, the network 104 may include a public network, such as the Internet, a private network, such as an intranet, or combinations thereof, and may utilize a variety of networking protocols now available or later developed including, but not limited to TCP/IP based networking protocols.

The first user device 102 may refer to a user device associated with a first user as defined above and may be a cellular telephone (e.g., a smartphone and/or other type of mobile telephone), laptop, tablet, electronic reader, e-book device, media device, wearable, smart glasses, smartwatch, or any combination of the above. Similarly, the second user device 106 may refer to a user device associated with a second user as defined above and may also be a cellular telephone (e.g., a smartphone and/or other type of mobile telephone), laptop, tablet, electronic reader, e-book device, media device, wearable, smart glasses, smartwatch, or any combination of the above. Although only a first user device 102 and a second user device 106 are illustrated, the example system 100 may include any number of user devices associated with the same user or any number of respective other users.

The enterprise payee database 110 may be stored by any suitable storage device configured to store some or all of the information described herein (e.g., memory 204 of the payment server 200 or a separate memory system separate from the payment server 200, such as one or more database systems, backend data servers, network databases, cloud storage devices, or the like provided by another device (e.g., online application or 3rd party provider) or the first or second user devices 102, 106). The enterprise payee database 110 may comprise data received from the payment server 200 (e.g., via a memory 204 and/or processor(s) 202), the first user device 102, or the second user device 106, and the corresponding storage device may thus store this data. As described above, the enterprise payee database may exist supported by or otherwise as a part of a financial institution's system in order to provide authenticated payment data (e.g., known valid payment data) as described hereafter.

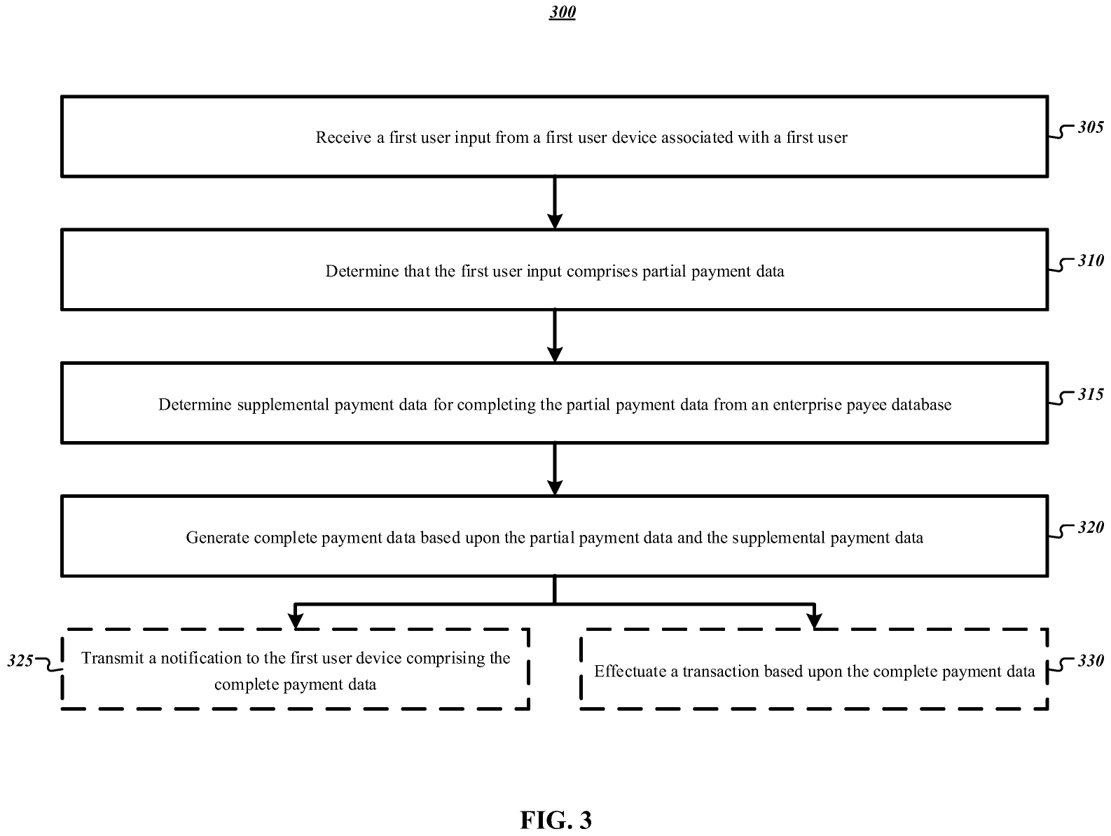

As illustrated in FIG. 2, the payment server 200 may include a processor 202, a memory 204, communications circuitry 208, and input/output circuitry 206. Moreover, the payment server 200 may include input analysis circuitry 210, data connection circuitry 212, and payment circuitry 214. The payment server 200 may be configured to execute the operations described below in connection with FIGS. 3-6. Although components 202-214 are described in some cases using functional language, it should be understood that the particular implementations necessarily include the use of particular hardware. It should also be understood that certain of these components 202-214 may include similar or common hardware. For example, two sets of circuitry may both leverage use of the same processor 202, memory 204, communications circuitry 208, or the like to perform their associated functions, such that duplicate hardware is not required for each set of circuitry. The use of the term “circuitry” as used herein includes particular hardware configured to perform the functions associated with respective circuitry described herein. As described in the example above, in some embodiments, various elements or components of the circuitry of the payment server 200 may be housed within the first user device 102 and/or the second user device 106. It will be understood in this regard that some of the components described in connection with the payment server 200 may be housed within one of these devices, while other components are housed within another of these devices, or by yet another device not expressly illustrated in FIG. 1.

Of course, while the term “circuitry” should be understood broadly to include hardware, in some embodiments, the term “circuitry” may also include software for configuring the hardware. For example, although “circuitry” may include processing circuitry, storage media, network interfaces, input/output devices, and the like, other elements of the payment server 200 may provide or supplement the functionality of particular circuitry.

In some embodiments, the processor 202 (and/or co-processor or any other processing circuitry assisting or otherwise associated with the processor) may be in communication with the memory 204 via a bus for passing information among components of the payment server 200. The memory 204 may be non-transitory and may include, for example, one or more volatile and/or non-volatile memories. In other words, for example, the memory may be an electronic storage device (e.g., a non-transitory computer readable storage medium). The memory 204 may be configured to store information, data, content, applications, instructions, or the like, for enabling the payment server 200 to carry out various functions in accordance with example embodiments of the present disclosure.

The processor 202 may be embodied in a number of different ways and may, for example, include one or more processing devices configured to perform independently. Additionally, or alternatively, the processor may include one or more processors configured in tandem via a bus to enable independent execution of instructions, pipelining, and/or multithreading. The use of the term “processing circuitry” may be understood to include a single core processor, a multi-core processor, multiple processors internal to the payment server, and/or remote or “cloud” processors.

In an example embodiment, the processor 202 may be configured to execute instructions stored in the memory 204 or otherwise accessible to the processor 202. Alternatively, or additionally, the processor 202 may be configured to execute hard-coded functionality. As such, whether configured by hardware or by a combination of hardware with software, the processor 202 may represent an entity (e.g., physically embodied in circuitry) capable of performing operations according to an embodiment of the present disclosure while configured accordingly. Alternatively, as another example, when the processor 202 is embodied as an executor of software instructions, the instructions may specifically configure the processor 202 to perform the algorithms and/or operations described herein when the instructions are executed.

The payment server 200 further includes input/output circuitry 206 that may, in turn, be in communication with processor 202 to provide output to a user and to receive input from a user, user device, or another source. In this regard, the input/output circuitry 206 may comprise a display that may be manipulated by a mobile application. In some embodiments, the input/output circuitry 206 may also include additional functionality such as a keyboard, a mouse, a joystick, a touch screen, touch areas, soft keys, a microphone, a speaker, or other input/output mechanisms. The processor 202 and/or user interface circuitry comprising the processor 202 may be configured to control one or more functions of a display through computer program instructions (e.g., software and/or firmware) stored on a memory accessible to the processor (e.g., memory 204, and/or the like).

The communications circuitry 208 may be any means such as a device or circuitry embodied in either hardware or a combination of hardware and software that is configured to receive and/or transmit data from/to a network and/or any other device, circuitry, or module in communication with the payment server 200. In this regard, the communications circuitry 208 may include, for example, a network interface for enabling communications with a wired or wireless communication network. For example, the communications circuitry 208 may include one or more network interface cards, antennae, buses, switches, routers, modems, and supporting hardware and/or software, or any other device suitable for enabling communications via a network. Additionally, or alternatively, the communication interface may include the circuitry for interacting with the antenna(s) to cause transmission of signals via the antenna(s) or to handle receipt of signals received via the antenna(s). These signals may be transmitted by the payment server 200 using any of a number of wireless personal area network (PAN) technologies, such as Bluetooth® v1.0 through v3.0, Bluetooth Low Energy (BLE), infrared wireless (e.g., IrDA), ultra-wideband (UWB), induction wireless transmission, or the like. In addition, it should be understood that these signals may be transmitted using Wi-Fi, Near Field Communications (NFC), Worldwide Interoperability for Microwave Access (WiMAX) or other proximity-based communications protocols.

The input analysis circuitry 210 includes hardware components designed to determine that a user input includes partial payment data. Furthermore, the input analysis circuitry 210 may determine supplemental payment data for completing the partial payment data from the enterprise payment database as described herein. The input analysis circuitry 210 may utilize processing circuitry, such as the processor 202, to perform its corresponding operations, and may utilize memory 204 to store collected information. In some instances, the input analysis circuitry 210 may obtain candidate payment data with associated confidence parameters, determine confidence thresholds associated with partial payment data, and determine if the confidence parameters satisfies the confidence threshold.

The data connection circuitry 212 includes hardware components designed to generate complete payment data based upon the partial payment data and the supplemental payment data. The data connection circuitry 212 may utilize processing circuitry, such as the processor 202, to perform its corresponding operations, and may utilize memory 204 to store collected information.

The payment circuitry 214 includes hardware components designed to effectuate a transaction between a first user account associated with the first user and a second user account associated with a second user. The payment circuitry 214 may utilize processing circuitry, such as the processor 202, to perform its corresponding operations, and may utilize memory 204 to store collected information.

It should also be appreciated that, in some embodiments, the input analysis circuitry 210, data connection circuitry 212, or payment circuitry 214, may include a separate processor, specially configured field programmable gate array (FPGA), or application specific interface circuit (ASIC) to perform its corresponding functions.

In addition, computer program instructions and/or other type of code may be loaded onto a computer, processor or other programmable payment server's circuitry to produce a machine, such that the computer, processor other programmable circuitry that execute the code on the machine create the means for implementing the various functions, including those described in connection with the components of payment server 200.

As described above and as will be appreciated based on this disclosure, embodiments of the present disclosure may be configured as systems, methods, mobile devices, and the like. Accordingly, embodiments may comprise various means including entirely of hardware or any combination of software with hardware. Furthermore, embodiments may take the form of a computer program product comprising instructions stored on at least one non-transitory computer-readable storage medium (e.g., computer software stored on a hardware device). Any suitable computer-readable storage medium may be utilized including non-transitory hard disks, CD-ROMs, flash memory, optical storage devices, or magnetic storage devices.

### Example Operations for Payment Determinations

FIG. 3 illustrates a flowchart containing a series of operations for providing payment determinations. The operations illustrated in FIG. 3 may, for example, be performed by, with the assistance of, and/or under the control of an apparatus (e.g., payment server 200), as described above. In this regard, performance of the operations may invoke one or more of processor 202, memory 204, input/output circuitry 206, communications circuitry 208, input analysis circuitry 210, data connection circuitry 212, and/or payment circuitry 214.

As shown in operation 305, the apparatus (e.g., payment server 200) includes means, such as input/output circuitry 206, communications circuitry 208, or the like, for receiving a first user input from a first user device 102 associated with a first user. In some example embodiments, the first user may input payment data (in whole or in part) via their first user device 102 as part of completing a financial transaction, for example, with the second user of the second user device 106. The payment server 200 may be support or otherwise be operably connected with, for example, an application of the first user device 102 that receives the first user input. In such an embodiment, the first user input by the first user via the first user device 102 may be received by the payment server 200 in response to the first user input (e.g., an automatic transmission to the payment server 200). In instances in which the payment server 200 is formed as part of the system of a financial institution or otherwise separate from the first user device 102, the payment server 200 may receive the first user input (e.g., payment data) in response to a transmission by the first user device 102 to the payment server 200.

In some example embodiments, the communications circuitry 208 may receive the first user input from the first user device 102 in response to a request for payment, for example, from the second user device 106. As described herein, a payee to a transaction may, in some instances, request payment associated with a transaction and may transmit such a request for payment to the payment server 200 and/or the first user device 102. In response to the request for payment, the first user may input the first user input via the first user device 102, and the first user device 102 may transmit the first user input to the payment server 200 associated with the request for payment. Although described herein with reference to mobile applications supported by the first user device 102 and request for payment transmitted by the second user device 106, the present disclosure contemplates that the payment server 200 may receive the first user input at operation 305 as part of any interaction by the payment server 200, the first user device 102, and/or the second user device 106.

As described hereafter, the first user input may include payment data (e.g., partial payment data as described with reference to operation 310) that is inputted via one or more field, input locations, or the like, presented to the first user via the first user device 102. By way of example, a user interface presented to the first user via the first user device 102 may include one or more free text entry fields each associated with a particular type of payment data. By way of continued example, the first user device 102 may present a field associate with the type (e.g., ACH, wire transfer, real-time payment, etc.) of transaction, a field associated with the payment date for the transaction, a field associated with the payment amount of the transaction, and/or a field associated with the payee's identification (e.g., account number, name, etc.). Although described herein with free text entry fields, the present disclosure contemplates that the first user input via the first user device 102 may be received via any form or input by which payment data may be inputted.

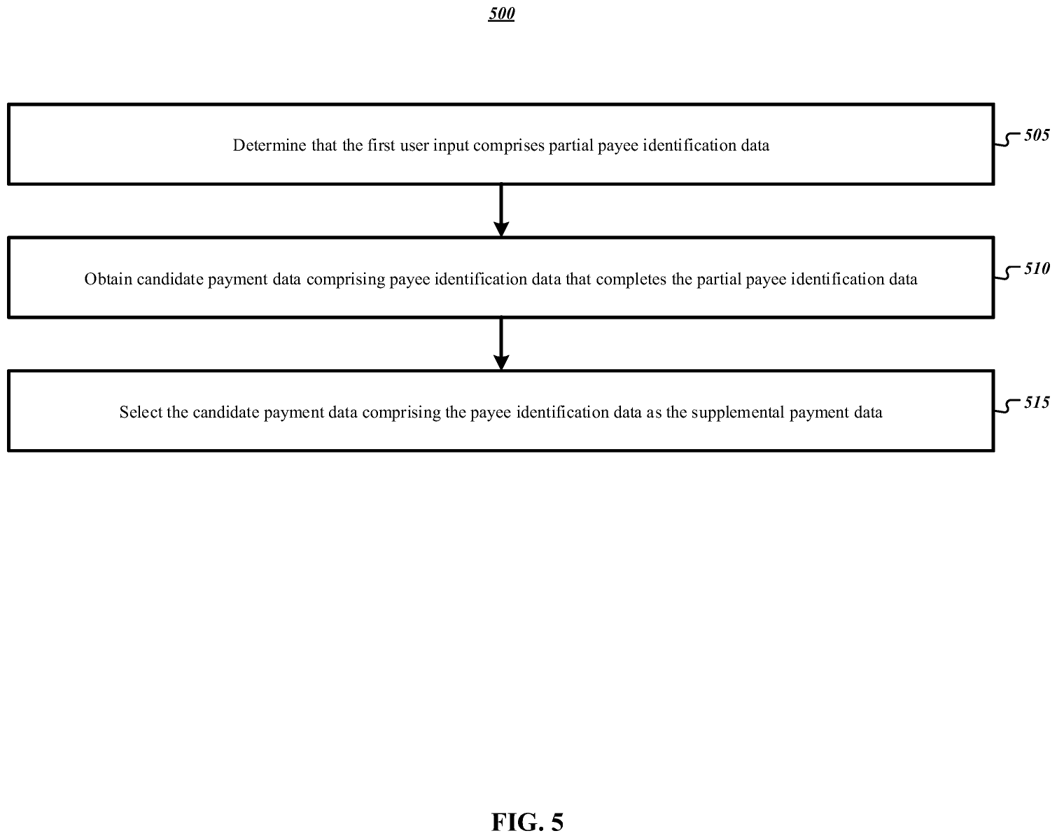

Thereafter, as shown in operation 310, the apparatus (e.g., payment server 200) includes means, such as input/output circuitry 206, input analysis circuitry 210, or the like, for determining that the first user input comprises partial payment data. As described above, the first user may input a first user input via the first user device 102, such as via one or more free text fields. The first user input received at operation 305, however, may include partial payment data. In some instances, the partial payment data may refer to an instance in which the entire input by the first user (e.g., the first user input) is incomplete. By way of example, the first user input at operation 305 may include partial payee identification data (e.g., a portion of the payee's name) in that the input is incomplete as described hereafter with reference to FIG. 5. Said differently, the first user input of the payee's name may be “Example Company” when the correct or intended payee name is “Example Company Inc.”. In such an embodiment, the input analysis circuitry 210 may determine that the first user input includes partial payment data by comparing the first user input with potential payee names known to the payment server 200 (e.g. stored by the enterprise payee database 110).

In some instances, the partial payment data may refer to an instance in which the first input by the first user (e.g., the first user input) that is currently inputted by the first user is incomplete. By way of example, the first user input at operation 305 may include instances in which the first user is actively inputting payment data via the first user device 102 (e.g., during input). In such an example embodiment, the partial payee identification data (e.g., a portion of the payee's name) may refer to the yet to be completed input of the first user. Said differently, the first user input of the payee's name may be “Example Com . . . ” when the correct payee name is “Example Company Inc.”. In such an embodiment, the input analysis circuitry 210 may also determine that the first user input includes partial payment data by comparing the first user input with potential payee names known to the payment server 200 (e.g. stored by the enterprise payee database 110). Such an example embodiment may refer to instances in which the method 300 operates as an autocomplete or predictive completion function for payment data inputs.

In some instances, the partial payment data may refer to an instance in which the first input by the first user (e.g., the first user input) that is inputted by the first user is incorrect. By way of example, the first user input at operation 305 may include instances in which the first user inputs payment data via the first user device 102 that includes incorrect payment data for the intended payee. For example, the first user input of the payee's name may be “Example Company Ltd.” when the correct payee name is “Example Company Inc.”. In such an embodiment, the input analysis circuitry 210 may also determine that the first user input includes partial payment data (e.g., incorrect payment data) by comparing the first user input with potential payee names known to the payment server 200 (e.g. stored by the enterprise payee database 110). Although described above with reference to partial payee identification data in the form of a payee name, the present disclosure contemplates that the partial payment data determined at operation 310 may refer to any portion, parameter, input, data entry, or the like that is incomplete or incorrect.

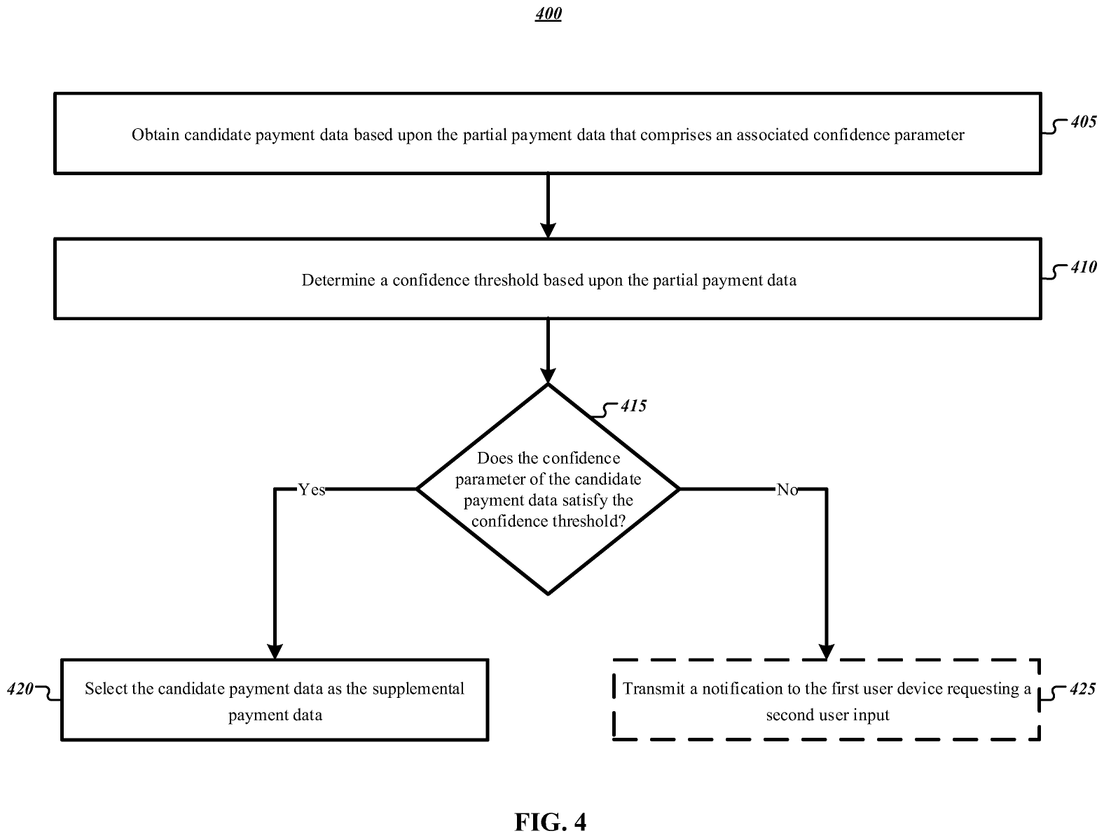

Thereafter, as shown in operation 315, the apparatus (e.g., payment server 200) includes means, such as processor 202, input analysis circuitry 210, or the like, for determining supplemental payment data for completing the partial payment data from an enterprise payee database. As described further with reference to FIG. 4 and defined above, the enterprise payee database 110 refers to a data structure or repository for storing user data, user parameters, financial transaction data, payment data, and the like from a plurality of user devices, users, and financial transactions. The enterprise payee database 110 includes authenticated payment data that is populated by transactions between a plurality of user devices and is dynamically updated in real-time or substantially real-time to include new financial transactions and/or modifications to prior financial transactions (e.g. dynamically updated payment data). As such, the embodiments described herein may leverage the authenticated payment data of the enterprise payee database 110 to determine supplemental payment data that completes the partial payment data of the first user input.

In an instance in which the first user input received at operation 305 includes partial payment data that is incomplete (e.g., either due to user omission or during active input by the user), the supplemental payment data determined at operation 315 may refer to payment data that completes or otherwise provides the data lacking from the first user input. For example, the enterprise payee database 110 may include payment data and prior transactions of the first user including prior payee names, payment amounts, payment dates, account numbers, and/or the like. Additionally, the enterprise payee database 110 may also include payment data and prior transactions of the second user and a plurality of other users including payee names, payment amounts, payment dates, account numbers, and the like for all transactions associated with the payment server 200. In order to determine the supplemental payment data to complete the partial payment data that includes incomplete payment data, the input analysis circuitry 210 may identify payment data of the enterprise payment database 110 that, with an associated confidence as described hereafter, completes the partial payment data.

For example, the first user input of the payee's name may be “Example Company.” In such an embodiment, the input analysis circuitry 210 may identify candidate payment data of the enterprise payment database 110 that may potentially complete the partial payment data. Example candidate payment data for the payee name may, for example, include “Example Co.”, “Example Company Inc.”, “Example Comp.”, “Example Company Ltd.”, and the like. As described with reference to FIG. 4 hereafter, each candidate payment data may include an associated confidence parameter indicative of the input analysis circuitry's 210 confidence that the candidate payment data correctly completes the partial payment data. In some instances, the confidence parameter may include a similarity, in the case of a payee name, between the number of characters in the payee name of the partial payment data and the payee name of the candidate payment data. For example, the confidence parameter for the candidate payment data “Example Company Inc.” may be 0.786 or 11/14 in that the candidate parameter having 14 letters shares 11 letters with the partial payment data.

In instances in which the confidence parameter is similar or equivalent between candidate payment data (e.g., between “Example Company Inc.” and “Example Company Ltd.”), the input analysis circuitry 210 may leverage authenticated payment data of the enterprise payee database 110. For example, the supplemental payment data at operation 315 may be determined by analyzing prior transactions of the first user and first user device 102. The user input analysis 210, for example, may identify prior transactions between the first user and first user device 102 and the payee “Example Company Inc.” and select this candidate data as the supplemental payment data. Although described herein with reference to transactions of the first user and first user device 102, the present disclosure contemplates that transactions of other users and user devices may similarly be used. For example, a plurality of users and user devices may have completed transactions with the payee “Example Company Inc.” having the same transaction date and/or amount as the first user and first user device 102 (e.g., indicative of “Example Company Inc.” being the correct payee).

Thereafter, as shown in operation 320, the apparatus (e.g., payment server 200) includes means, such as the processor 202, the data connection circuitry 212, or the like, for generating complete payment data based upon the partial payment data and the supplemental payment data. As described above, the supplemental payment data determined at operation 315 may operate to, in the case of incomplete payment data, complete the partial payment data by adding additional payment data (e.g., supplemental payment data) such that the partial payment data matches that of the data of the enterprise payee database 110 (e.g., authenticated payment data). In the case of incorrect payment data, the data connection circuitry 2112 may complete the partial payment data by replacing portions of the partial payment data with supplemental payment data such that the partial payment data matches that of the data of the enterprise payee database 110 (e.g., authenticated payment data). The complete data generated at operation 320 may therefore match the payment data of the enterprise payee database 110 to ensure that the payment data accurately reflects the intended payee of the financial transaction. Additionally, the method illustrated in FIG. 3 further minimizes storage and computational burdens associated with conventional payment transaction systems by minimizing or eliminating faulty transactions. Said differently, the failure of conventional systems to address partial payment data results in iterative or redundant transactions completed by these systems resulting in increased computation and storage requirements to allow for the interactive or redundant transactions.

In some embodiments, as shown in operation 325, the apparatus (e.g., payment server 200) includes means, such as the processor 202, the communications circuitry 208, or the like, for transmitting a notification to the first user device 102 comprising the complete payment data. By way of example, the payment server 200 may determine partial payment data as described above and supplemental data necessary to complete the partial payment data (generated as complete payment data). At operation 325, the payment server 200 may notify the first user via the first user device 102 of the partial payment data in the first user input. The notification may identify the partial payment data, the supplemental payment data, and the complete payment data for review and approval by the first user. Said differently, the transmission provided at operation 325 may operate to allow the first user to confirm that the complete payment data matches the intent of the first user input.

In some embodiments, as shown in operation 330, the apparatus (e.g., transaction server 200) includes means, such as the processor 202, the payment circuitry 214, or the like, for effectuating a transaction based upon the complete payment data. In some embodiments, the payment server 200 may be communicably coupled a first user account associated with the first user device 102 such as instances in which the payment server 200 is associated with a financial institution or banking entity. In such an embodiment, the complete data generated at operation 320 may be effectuated in that the payment circuitry 214 of the payment server 200 may cause funds to be dispersed from the first user account of the first user and first user deice 102 in satisfaction of the fees associated with the complete payment data. In some embodiments the payment server 200 may further be communicably coupled with a second user account associated with a second user device 106. In an instance in which the complete payment data identifies the second user as the payee, the payment circuitry 214 may cause funds to be dispersed from the first user account to the second user account as dictated by the complete payment data.

In some embodiments, the effectuation of a transaction at operation 330 may include determination of an optimal or recommended payment method (e.g., payment rail or other payment mechanism). In particular, the complete payment data may include the payment amount, recipient, timing parameters, and/or the like, and the payment server 200 may analyze the complete payment data in order to determine the recommended or optimal method for completing the transaction. By way of example, the payment server 200 may determine that the timing parameters of the complete payment data require a relatively fast transmission time and may select a real-time payment (RTP) as the mechanism for effectuating the payment. In other example implementations, the payment server 200 may determine that the timing parameters of the complete payment data do not specify a transmission time and may, thus, select an ACH transaction to reduce the fees associated with the transaction. Although described herein with reference to timing parameters, the present disclosure contemplates that any data entry of the complete payment data may be used to select the optimal method or mechanism for effectuating the payment.

Turning next to FIG. 4, a flowchart is shown for confidence parameter comparisons. The operations illustrated in FIG. 4 may, for example, be performed by, with the assistance of, and/or under the control of an apparatus (e.g., payment server 200), as described above. In this regard, performance of the operations may invoke one or more of processor 202, memory 204, input/output circuitry 206, communications circuitry 208, input analysis circuitry 210, data connection circuitry 212, and/or payment circuitry 214.

As shown in operation 405, the apparatus (e.g., payment server 200) includes means, such as input/output circuitry 206, input analysis circuitry 210, or the like, for obtaining candidate payment data based upon the partial payment data that comprises an associated confidence parameter. As described above with reference to operation 315, the input analysis circuitry 210 may identify candidate payment data of the enterprise payment database 110 that may potentially complete the partial payment data. Example candidate payment data for the payee name may, for example, include “Example Co.”, “Example Company Inc.”, “Example Comp.”, “Example Company Ltd.”, and the like. Each candidate payment data may include an associated confidence parameter indicative of the input analysis circuitry's 210 confidence that the candidate payment data correctly completes the partial payment data. By way of continued example, the confidence parameter may include a similarity, in the case of a payee name, between the number of characters in the payee name of the partial payment data and the payee name of the candidate payment data. For example, the confidence parameter for the candidate payment data “Example Company Inc.” may be 0.786 or 11/14 in that the candidate parameter having 14 letters shares 11 letters with the partial payment data. Although described herein with reference to a numerical value of the similarly in letters between the partial payment data and the candidate payment data, the present disclosure contemplates that other techniques (e.g. machine learning, natural language processing, etc.) may also be used to determine the confidence parameter associated with the candidate payment data.

As shown in operation 410, the apparatus (e.g., payment server 200) includes means, such as input/output circuitry 206, input analysis circuitry 210, or the like, for determining a confidence threshold based upon the partial payment data. The partial payment data of the first user input may include a type of payment (e.g., an ACH transaction, wire transfer, real-time payment, etc.) that is associated with a confidence threshold. By way of example, the payment server 200 may determine that an irrevocable payment type, such as a real-time payment, requires a higher confidence parameter to ensure that the complete payment data generated above is accurate. Said differently, the irrevocable nature of a real-time payment may be such that a larger risk exists in supplying funds to an incorrect payee due to the lack of redress in reacquiring the funds. By way of continued example, the input analysis circuitry 210 may determine that the payment type for the partial payment data is a real-time payment and determine a confidence threshold associated with the real time payment of, for example, 0.90 (e.g., a 90% similarly between the partial payment data and the candidate payment data).

As shown in operation 415, the apparatus (e.g., payment server 200) includes means, such as input/output circuitry 206, input analysis circuitry 210, or the like, for determining if the confidence parameter of the candidate payment data satisfies the confidence threshold. In an instance in which the determined confidence threshold is 0.9, the example confidence parameter of 0.786 described above for the candidate payment data “Example Company Inc.” fails to satisfy this confidence threshold. Alternatively, the input analysis circuitry 210 may determine that the payment type for the partial payment data is an ACH transaction (e.g., associated with less risk than a real-time payment) and determine a confidence threshold associated with the ACH transaction of 0.75. In an instance in which the determined confidence threshold is 0.75, the example confidence parameter of 0.786 described above for the candidate payment data “Example Company Inc.” satisfies this confidence threshold.

The determination of the confidence threshold at operation 410 may, in some instances, be determined by an initial set up procedure, input by a system administrator, or set by applicable regulations or standards. In other embodiments, however, the input analysis circuitry 210 may operate to dynamically adjust the confidence threshold based upon the partial payment data. For example, the input analysis circuitry 210 may identify partial payment data relating to a payment amount and may determine that the payment amount is associated with low risk (e.g., a minute financial liability as related to the finances of the first user) and may reduce the confidence threshold based upon this determination. Alternatively, the input analysis circuitry 210 may identify partial payment data relating to a payment amount and may determine that the payment amount is associated with high risk (e.g., a large financial liability as related to the finances of the first user) and may increase the confidence threshold based upon this determination. Although described herein with reference to a payment amount, the present disclosure contemplates that the confidence threshold may be dynamically adjusted based upon any partial payment data.

In an instance in which the confidence parameter of the candidate payment data satisfies the confidence threshold, as shown in operation 420, the apparatus (e.g., payment server 200) includes means, such as input/output circuitry 206, input analysis circuitry 210, or the like, for selecting the candidate payment data as the supplemental payment data. As described above at operation 320, the supplemental payment data including the candidate payment data may complete the partial payment data by adding additional payment data or replacing incorrect data such that the partial payment data matches that of the data of the enterprise payee database 110 (e.g., authenticated payment data).

In an instance in which the confidence parameter of the candidate payment data fails to satisfy the confidence threshold, as shown in operation 425, the apparatus (e.g., payment server 200) includes means, such as input/output circuitry 206, input analysis circuitry 210, or the like, for transmitting a notification to the first user device 102 requesting a second user input. In some instances, the partial payment data received by the payment server 200 may be insufficient to for determining supplemental payment data as described herein. For example, a first user input may include partial payment data associated with a payee name of “Ex . . . ” such that the input analysis circuitry 210 lacks sufficient payment data to perform the operations of FIGS. 3-4. As such, in some embodiments, the communications circuitry 208 may transmit a notification to the first user device 102 requesting a second user input that include additional payment data. Upon receipt of the second user input, the payment server 200 may repeat the operations of FIGS. 3-4 in order to generate complete payment data.

Turning next to FIG. 5, a flowchart is shown for example partial payee identification determinations. The operations illustrated in FIG. 5 may, for example, be performed by, with the assistance of, and/or under the control of an apparatus (e.g., payment server 200), as described above. In this regard, performance of the operations may invoke one or more of processor 202, memory 204, input/output circuitry 206, communications circuitry 208, input analysis circuitry 210, data connection circuitry 212, and/or payment circuitry 214.

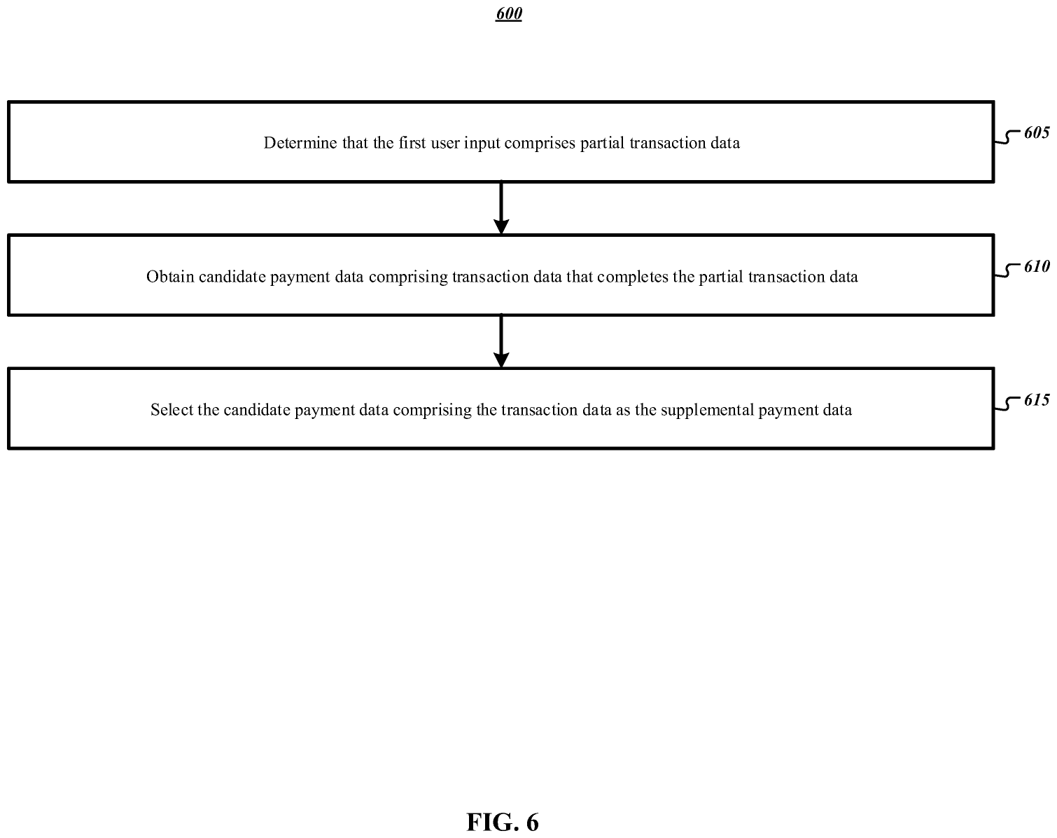

As shown in operation 505, the apparatus (e.g., payment server 200) includes means, such as input/output circuitry 206, input analysis circuitry 210, or the like, determining that the first user input comprises partial payee identification data. The partial payee identification data as described herein may refer to payment data associated with the payee including, for example, a payee name, payee account number, payee address, or other identifying information of the payee. By way of example, the first user input may include a portion of the account number of the intended payee, and the input analysis circuitry 210 may determine that the first user input comprises partial payee identification data in response to such a first user input. Although the first user input may also include partial payment data that comprises partial transaction data as described hereafter with reference to FIG. 6, the embodiment of FIG. 5 is directed to candidate payment data that addresses incomplete or incorrect payee identification data.

In such an example embodiment, as shown in operation 510, the apparatus (e.g., payment server 200) includes means, such as the processor 202, the input analysis circuitry 210, or the like, for obtaining candidate payment data comprising payee identification data that completes the partial payee identification data. By way of example, the partial payment data may include partial payee identification data relating to a partial account number of the intended payee (e.g., Acct #: 123456 . . . ). In an instance in which the account numbers of the enterprise payee database 110 include 7 digits, the partial payee identification data may be insufficient as inputted to complete the payment. As such, the input analysis circuitry 210 may, for example, obtain candidate payment data (e.g., Acct #: 1234560, Acct #: 1234561, Acct #: 1234562, . . . , Acct #: 1234569) for completing the partial payee identification data. In such an example, the payment server 200 may further leverage payment data of the enterprise payee database 110 to select the candidate payment data that completes the partial payee identification data. For example, the payment server 200 may identify prior transactions for the first user and first user device 102 from the enterprise payee database 110 with similar account numbers and/or prior transactions of the first user on similar dates (e.g., the same date of the month) or similar amounts (e.g., the same payment amount of a prior month). Additionally, the payment server 200 may identify transactions for the second user and second user device 106 (e.g. or any other user and user device) from the enterprise payee database 110 with similar account numbers and/or transactions of the second user on similar dates (e.g., a payment due the same date as the first user's transaction) or similar amounts (e.g., the same payment amount as the first user's transaction).

Thereafter, as shown in operation 515, the apparatus (e.g., payment server 200) includes means, such as the processor 202, the input analysis circuitry 210, data connection circuitry 212, or the like, for selecting the candidate payment data comprising the payee identification data as the supplemental payment data. As described above at operations 320 and 420, the supplemental payment data including the candidate payment data may complete the partial payment data by adding additional payment data or replacing incorrect data such that the partial payment data matches that of the data of the enterprise payee database 110 (e.g., authenticated payment data). Through various iterations of the operations of FIG. 5, the payment server 200 may also further improve the selection of candidate payment data that incudes payee identification data. Said differently, iterative association of candidate payment data of the enterprise payee database 110 with the partial payment data inputted by the first user may operate to improve subsequent performance of the candidate payment data selections for partial payee identification data.

Turning next to FIG. 6, a flowchart is shown for example partial transaction data determinations. The operations illustrated in FIG. 6 may, for example, be performed by, with the assistance of, and/or under the control of an apparatus (e.g., payment server 200), as described above. In this regard, performance of the operations may invoke one or more of processor 202, memory 204, input/output circuitry 206, communications circuitry 208, input analysis circuitry 210, data connection circuitry 212, and/or payment circuitry 214.

As shown in operation 605, the apparatus (e.g., payment server 200) includes means, such as input/output circuitry 206, communications circuitry 208, or the like, for determining that the first user input comprises partial transaction data. The partial transaction data as described herein may refer to payment data associated with a transaction including, for example, a payment type, payment amount, payment date, or other identifying information of the transaction. By way of example, the first user input may include a portion of the payment amount for providing to the intended payee, and the input analysis circuitry 210 may determine that the first user input comprises partial transaction data in response to such a first user input. Although the first user input may also include partial payment data that comprises partial payee identification data as described with reference to FIG. 5, the embodiment of FIG. 6 is directed to candidate payment data that addresses incomplete or incorrect transaction data.

In such an example embodiment, as shown in operation 610, the apparatus (e.g., payment server 200) includes means, such as the processor 202, the input analysis circuitry 210, or the like, for obtaining candidate payment data comprising payee identification data that completes the partial payee identification data. By way of example, the partial payment data may include partial transaction data relating to a partial payment amount for sending to intended payee (e.g., $1,02 . . . ). As such, the input analysis circuitry 210 may, for example, obtain candidate payment data (e.g., $1,020.00, $1,020.01, $1,020.02, . . . , $1,029.99) for completing the partial transaction data. In such an example, the payment server 200 may further leverage payment data of the enterprise payee database 110 to select the candidate payment data that completes the partial transaction data. For example, the payment server 200 may identify prior transactions for the first user and first user device 102 from the enterprise payee database 110 on similar dates (e.g., the same date of the month) or similar amounts (e.g., the same payment amount of a prior month). Additionally, the payment server 200 may identify transactions for the second user and second user device 106 (e.g. or any other user and user device) from the enterprise payee database 110 with similar transactions of the second user on similar dates (e.g., a payment due the same date as the first user's transaction) or similar amounts (e.g., a similar payment amount to the first user's transaction).

Thereafter, as shown in operation 615, the apparatus (e.g., payment server 200) includes means, such as the processor 202, the input analysis circuitry 210, data connection circuitry 212, or the like, for selecting the candidate payment data comprising the payee identification data as the supplemental payment data. As described above at operations 320, 420, and 520, the supplemental payment data including the candidate payment data may complete the partial payment data by adding additional payment data or replacing incorrect data such that the partial payment data matches that of the data of the enterprise payee database 110 (e.g., authenticated payment data). Through various iterations of the operations of FIG. 6, the payment server 200 may also further improve the selection of candidate payment data that incudes transaction data. Said differently, iterative association of candidate payment data of the enterprise payee database 110 with the partial payment data inputted by the first user may operate to improve subsequent performance of the candidate payment data selections for partial transaction data.

As described above, various technical challenges are surmounted via technical solutions contemplated herein. For instance, example implementations of embodiments of the present disclosure utilize an enterprise payee database/directory that includes authenticated payment data populated and dynamically updated in real-time by transactions between a plurality of user devices to ensure proper payment determinations. In operation, embodiments of the present disclosure may receive a user input from a first user device associated with a first user that includes partial payment information. The system may determine supplemental payment data that completes the partial payment data from an enterprise payee database that includes authenticated payment data as described above. The system may further generate complete payment data based upon the partial payment data from the first user input and the supplemental payment data. Additional example embodiments, may, in the process of determining supplemental data, obtain candidate payment data with associated confidence parameters and compare the confidence parameters with a confidence threshold of the partial payment data in order to ensure the accuracy of the complete payment data use to complete the transaction. In this way, the inventors have identified that the advent of new payment technologies have created a new opportunity for solutions for providing accurate payment and payee determinations which were historically unavailable. In doing so, such example implementations confront and solve at least two technical challenges: (1) they generate complete payment data that accurately reflects the intended payee of a financial transaction, and (2) they minimize storage and computational burdens associated with payment transaction systems.

FIGS. 3-6 thus illustrate flowcharts describing the operation of apparatuses, methods, and computer program products according to example embodiments contemplated herein. It will be understood that each flowchart block, and combinations of flowchart blocks, may be implemented by various means, such as hardware, firmware, processor, circuitry, and/or other devices associated with execution of software including one or more computer program instructions. For example, one or more of the operations described above may be implemented by an apparatus executing computer program instructions. In this regard, the computer program instructions may be stored by a memory 204 of the payment server 200 and executed by a processor 202 of the payment server 200. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture, the execution of which implements the functions specified in the flowchart blocks. The computer program instructions may also be loaded onto a computer or other programmable apparatus to cause a series of operations to be performed on the computer or other programmable apparatus to produce a computer-implemented process such that the instructions executed on the computer or other programmable apparatus provide operations for implementing the functions specified in the flowchart blocks.

The flowchart blocks support combinations of means for performing the specified functions and combinations of operations for performing the specified functions. It will be understood that one or more blocks of the flowcharts, and combinations of blocks in the flowcharts, can be implemented by special purpose hardware-based computer systems which perform the specified functions, or combinations of special purpose hardware with computer instructions.

### CONCLUSION

Many modifications and other embodiments of the disclosure set forth herein will come to mind to one skilled in the art to which these embodiments pertain having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A method for payment determinations, the method comprising:
receiving a first user input from a first user device associated with a first user;
comparing a data parameter of the first user input with data parameters stored within an enterprise payee database, wherein the enterprise payee database comprises authenticated payment data populated by transactions between a plurality of user devices;
in an instance in which the data parameter of the first user input fails to correspond to any data parameters stored within the enterprise payee database, determining that the first user input comprises incorrect partial payment data;
adjusting a confidence threshold based upon the incorrect partial payment data, wherein the confidence threshold is adjusted based on a risk determined for the incorrect partial payment data and finances of the first user;
obtaining candidate payment data from the enterprise payee database, wherein the candidate payment data is obtained from analysis of prior transactions of the first user or the first user device stored in the enterprise payee database;
determining supplemental payment data for correcting the incorrect partial payment data based on selected candidate payment data and the incorrect partial payment data, wherein (i) the supplemental payment data is determined in an instance in which a confidence parameter associated with the supplemental payment data satisfies the confidence threshold, (ii) the confidence parameter associated with the supplemental payment data is determined based on a number of matching characters between the incorrect partial payment data and at least a portion of the supplemental payment data, and (iii) the supplemental payment data comprises payment data that corrects the data parameter of the first user input;
generating complete payment data based upon the incorrect partial payment data and the supplemental payment data, wherein the payment data of the supplemental payment data replaces the data parameter of the first user input; and
effectuating a transaction between a first user account associated with the first user and a second user account as dictated by the complete payment data.

2. (canceled)

3. The method according to claim 1, further comprising transmitting a notification to the first user device comprising the complete payment data.

4. The method according to claim 1, wherein the candidate payment data is obtained based upon the incorrect partial payment data,
wherein the candidate payment data comprises an associated confidence parameter, and
wherein determining the supplemental payment data further comprises:
determining if the confidence parameter of the candidate payment data satisfies the confidence threshold; and
selecting the candidate payment data as the supplemental payment data in an instance in which the confidence parameter satisfies the confidence threshold.

5. The method according to claim 4, further comprising, in an instance in which the confidence parameter fails to satisfy the confidence threshold, transmitting a notification to the first user device requesting a second user input.

6. The method according to claim 1, wherein the incorrect partial payment data comprises incorrect partial payee identification data,
wherein obtaining the candidate payment data further comprises payee identification data that corrects the incorrect partial payee identification data of the incorrect partial payment data, and
wherein determining the supplemental payment data further comprises:
selecting the candidate payment data comprising the payee identification data as the supplemental payment data.

7. The method according to claim 1, wherein the incorrect partial payment data comprises incorrect partial transaction data,
wherein the candidate payment data comprises transaction data that corrects the incorrect partial transaction data of the incorrect partial payment data, and
wherein determining the supplemental payment data further comprises:
selecting the candidate payment data comprising the transaction data as the supplemental payment data.

8. An apparatus for providing payment determinations, the apparatus comprising:
communications circuitry configured to receive a first user input from a first user device associated with a first user;
input analysis circuitry configured to:
compare a data parameter of the first user input with data parameters stored within an enterprise payee database, wherein the enterprise payee database comprises authenticated payment data populated by transactions between a plurality of user devices;
in an instance in which the data parameter of the first user input fails to correspond to any data parameters stored within the enterprise payee database, determine that the first user input comprises incorrect partial payment data;
adjust a confidence threshold based upon the incorrect partial payment data, wherein the confidence threshold is adjusted based on a risk determined for the incorrect partial payment data and finances of the first user;
obtain candidate payment data from the enterprise payee database, wherein the candidate payment data is obtained from analysis of prior transactions of the first user or the first user device stored in the enterprise payee database; and
determine supplemental payment data for correcting the incorrect partial payment data based on selected candidate payment data and the incorrect partial payment data, wherein (i) the supplemental payment data is determined in an instance in which a confidence parameter associated with the supplemental payment data satisfies the confidence threshold, (ii) the confidence parameter associated with the supplemental payment data is determined based on a number of matching characters between the incorrect partial payment data and at least a portion of the supplemental payment data, and (iii) the supplemental payment data comprises payment data that corrects the data parameter of the first user input;
data connection circuitry configured to generate complete payment data based upon the incorrect partial payment data and the supplemental payment data, wherein the payment data of the supplemental payment data replaces the data parameter of the first user input; and
payment circuitry configured to effectuate a transaction between a first user account associated with the first user and a second user account as dictated by the complete payment data.

9. (canceled)

10. The apparatus according to claim 8, wherein the communications circuitry is further configured to transmit a notification to the first user device comprising the complete payment data.

11. The apparatus according to claim 8, wherein the candidate payment data is obtained based upon the incorrect partial payment data,
wherein the candidate payment data comprises an associated confidence parameter, and wherein the input analysis circuitry is further configured to:
determine if the confidence parameter of the candidate payment data satisfies the confidence threshold; and
select the candidate payment data as the supplemental payment data in an instance in which the confidence parameter satisfies the confidence threshold.

12. The apparatus according to claim 11, wherein the communications circuitry is further configured to, in an instance in which the confidence parameter fails to satisfy the confidence threshold, transmit a notification to the first user device requesting a second user input.

13. The apparatus according to claim 8, wherein the incorrect partial payment data comprises incorrect partial payee identification data,
wherein obtaining the candidate payment data further comprises payee identification data that corrects the incorrect partial payee identification data of the incorrect partial payment data, and
wherein the input analysis circuitry is further configured to:
select the candidate payment data comprising the payee identification data as the supplemental payment data.

14. The apparatus according to claim 8, wherein the incorrect partial payment data comprises incorrect partial transaction data;
wherein the candidate payment data comprises transaction data that corrects the incorrect partial transaction data of the incorrect partial payment data, and
wherein the input analysis circuitry is further configured to:
select the candidate payment data comprising the transaction data as the supplemental payment data.

15. A non-transitory computer-readable storage medium for providing payment determinations, the non-transitory computer-readable storage medium storing instructions that, when executed, cause an apparatus to:
receive a first user input from a first user device associated with a first user;
compare a data parameter of the first user input with data parameters stored within an enterprise payee database, wherein the enterprise payee database comprises authenticated payment data populated by transactions between a plurality of user devices;
in an instance in which the data parameter of the first user input fails to correspond to any data parameters stored within the enterprise payee database, determine that the first user input comprises incorrect partial payment data;
adjust a confidence threshold based upon the incorrect partial payment data, wherein the confidence threshold is adjusted based on a risk determined for the incorrect partial payment data and finances of the first user;
obtain candidate payment data from the enterprise payee database, wherein the candidate payment data is obtained from analysis of prior transactions of the first user or the first user device stored in the enterprise payee database;
determine supplemental payment data for correcting the incorrect partial payment data based on selected candidate payment data and the incorrect partial payment data, wherein (i) the supplemental payment data is determined in an instance in which a confidence parameter associated with the supplemental payment data satisfies the confidence threshold, (ii) the confidence parameter associated with the supplemental payment data is determined based on a number of matching characters between the incorrect partial payment data and at least a portion of the supplemental payment data, and (iii) the supplemental payment data comprises payment data that corrects the data parameter of the first user input;
generate complete payment data based upon the incorrect partial payment data and the supplemental payment data, wherein the payment data of the supplemental payment data replaces the data parameter of the first user input; and
effectuate a transaction between a first user account associated with the first user and a second user account as dictated by the complete payment data.

16. (canceled)

17. The non-transitory computer-readable storage medium according to claim 15, wherein the instructions, when executed, further cause the apparatus to transmit a notification to the first user device comprising the complete payment data.

18. The non-transitory computer-readable storage medium according to claim 15, wherein the candidate payment data is obtained based upon the incorrect partial payment data,
wherein the candidate payment data comprises an associated confidence parameter, and
wherein the instructions, when executed, further cause the apparatus to:
determine if the confidence parameter of the candidate payment data satisfies the confidence threshold; and
select the candidate payment data as the supplemental payment data in an instance in which the confidence parameter satisfies the confidence threshold.

19. The non-transitory computer-readable storage medium according to claim 15,
wherein the incorrect partial payment data further-comprises incorrect partial payee identification data,
wherein obtaining the candidate payment data further comprises payee identification data that corrects the incorrect partial payee identification data of the incorrect partial payment data, and
wherein the instructions, when executed, further cause the apparatus to:
select the candidate payment data comprising the payee identification data as the supplemental payment data.

20. The non-transitory computer-readable storage medium according to claim 15,
wherein the incorrect partial payment data comprises incorrect partial transaction data,
wherein the candidate payment data comprises transaction data that corrects the incorrect partial transaction data of the incorrect partial payment data, and
wherein the instructions, when executed, further cause the apparatus to:
select the candidate payment data comprising the transaction data as the supplemental payment data.

21. The method according to claim 1, further comprising dynamically adjusting the confidence threshold.

22. The apparatus according to claim 8, wherein the input analysis circuitry is further configured to dynamically adjust the confidence threshold.

23. (canceled)

24. The method according to claim 1, further comprising:
determining a liability for the incorrect partial payment data based on a comparison of a payment amount associated with the incorrect partial payment data and the finances of the first user; and
determining the risk for the incorrect partial payment data based on the determined liability.
